(19) United States
(12) Patent Application Publication
(10) Pub. No.: US 2014/0370334 A1
(43) Pub. Date: Dec. 18, 2014

(54) Apparatus and Method for Long Life Water Cells

(71) Applicant: PS Inventors, Inc., Yerington, NV (US)

(72) Inventor: James A. Siegrist, Cathedral City, CA (US)

(73) Assignee: PS Inventors, Inc., Yerington, NV (US)

(21) Appl. No.: 14/155,411

(22) Filed: Jan. 15, 2014

Related U.S. Application Data
(60) Provisional application No. 61/956,739, filed on Jun. 17, 2013.

(51) Int. Cl. H01M 10/04

(52) U.S. Cl. CPC H01M 10/0422
USPC 429/50; 429/94

(57) ABSTRACT

An apparatus and method for long life water cells are disclosed. The cells include two electrodes—an anode and a cathode separated by an absorbent material for connectivity such as cloth, sponge and/or absorbent coatings. The anode and cathode are cylindrically shaped and may be nested or stacked inside one another with the absorbent material positioned between them. A protective sealant coating made of epoxy, paint or glue deposited on the exterior surface of one or both of the electrodes is used to protect the electrodes and minimize oxidation to preserve and lengthen the life of the cell. Multiple cells may be connected in series to increase voltage and amperage.

### RELATED APPLICATION INFORMATION

This application claims priority benefit from U.S. Provisional Patent Application Ser. No. 61/956,739, filed on Jun. 17, 2013, the entirety of which is incorporated by reference in the present application.

### COPYRIGHT NOTICE

Portions of this disclosure contain material in which copyright is claimed by the applicant. The applicant has no objection to the copying of this material in the course of making copies of the application file or any patents that may issue on the application, but all other rights whatsoever in the copyrighted material are reserved.

### BACKGROUND

Voltaic cells, also referred to as galvanic cells, using chemical energy are known and can be used to produce electricity, which may in turn be used to provide power to any number of different devices. A brief general description of voltaic cells may be found at: http://www.wyzant.com/help/science/chemistry/voltaic-cells; or, at: http://en.wikipedia.org/wiki/Galvanic_cell, both of which descriptions are incorporated herein by reference.

In the above referenced webpages describing voltaic cells, such cells 100 as can be seen in FIG. 1 are described comprising two electrodes referred more specifically to as an anode 105 and a cathode 110, as well as a salt bridge 115, a wire 120 and two reaction vessels 125, 130. Anode 105 is formed from vessel 125 filled with zinc sulfate and having immersed in it an electrode 105 made of zinc. Cathode 110 is formed from vessel 130 filled with copper sulfate and having immersed in it an electrode 110 made of copper. While the specific design parameters may vary, the basic principles resulting from their composition is the same. In particular, an oxidation-reduction (i.e. electron transfer) reaction occurs between zinc electrode 105 and copper electrode 110, and the transferred electrons are forced through an electrical circuit 120. An oxidation-reduction reaction is referred to herein as a “redox” reaction. In a typical redox reaction, the reactants are mixed together in a single reaction vessel. When the reactants collide, one or more electrons are transferred and products are formed. For example, a Zn atom reacts with a Cu²⁺ ion to produce a Zn²⁺ ion and a Cu atom.

In this case, the electrons are transferred directly between the reactants, and the chemical energy is converted to heat. In a voltaic cell, the reactants are separated into two solutions and connected by a wire. The reactants do not collide forcing the electrons to be transferred indirectly through the wire, and the chemical energy is converted into electrical work.

A problem with the known voltaic cells described is that the components quickly corrode and fail. Further, the portable salt bridge, the number of cells and the liquid containment requirements for the required solution are all difficult to engineer for commercial use.

The present invention defines an apparatus and method for long life water cells that overcomes these problems. The cells of the present invention consist of two electrodes that are more specifically referred to as an anode and a cathode. The two electrodes are of different metallic composition and are separated by an absorbent material that holds moisture and facilitates the conductivity of electrons between the two electrodes. The electrodes and the absorbent material are immersed in a container or reservoir filled with water within which oxidation-reductions reactions occur between the two electrodes producing chemical energy that may be used as a power supply. A protective sealant coating applied to one or both electrodes protects the electrodes and reduces or stops the oxidation process and decay to prolong the life of the cell.

### BRIEF DESCRIPTION OF THE DRAWINGS

For a better understanding of the present invention, and to show more clearly how it functions, reference will now be made, by way of example, to the accompanying drawings. The drawings show embodiments of the present invention in which:

FIG. 1 shows a prior art galvanic cell;

FIG. 2A shows a complete water cell with an inner anode and an outer cathode;

FIG. 2B shows multiple water cells connected in series;

FIG. 2C shows multiple water cells in a configuration in which individual cells are stacked in layers within one another;

FIG. 2D is a detailed view of a top portion of the multiple cells of FIG. 1C;

FIGS. 3A-G show the composition of a nested or stacked cylindrical water cell;

FIGS. 4A-B show a cylinder shaped anode and a cutaway perspective view of the cylindrical anode with protective sealant coating;

FIGS. 4C-D show an anode formed from a coil and a cutaway perspective view of the coiled anode with protective sealant coating;

FIGS. 5A-C show views of an absorbent material;

FIG. 6 shows a lamp powered by water cells;

FIG. 7 shows a key chain light powered by water cells;

FIGS. 8A and 8B show a side view and front view respectively of a flashlight powered by water cells;

FIG. 9 shows a yard lamp powered by water cells; and

FIG. 10 is a block diagram of a circuit with a water cell power supply providing power to one or more bulbs in a lamp.

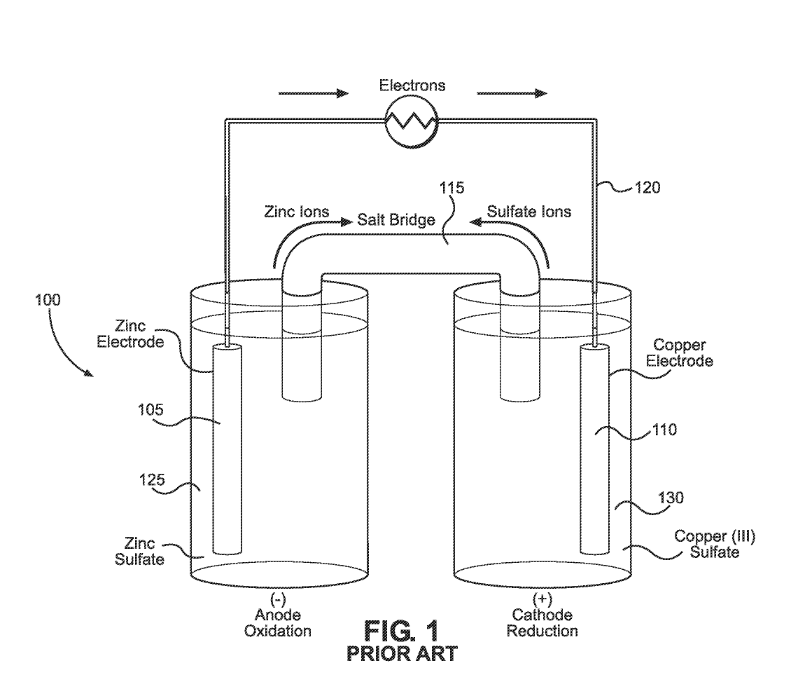

### DETAILED DESCRIPTION OF THE INVENTION

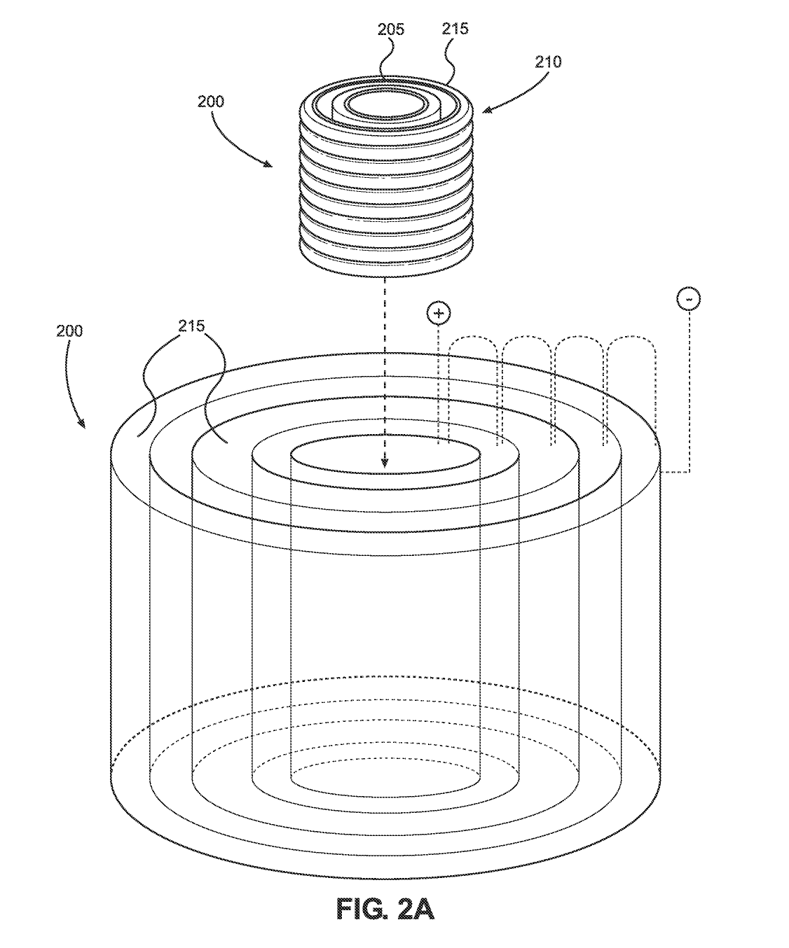

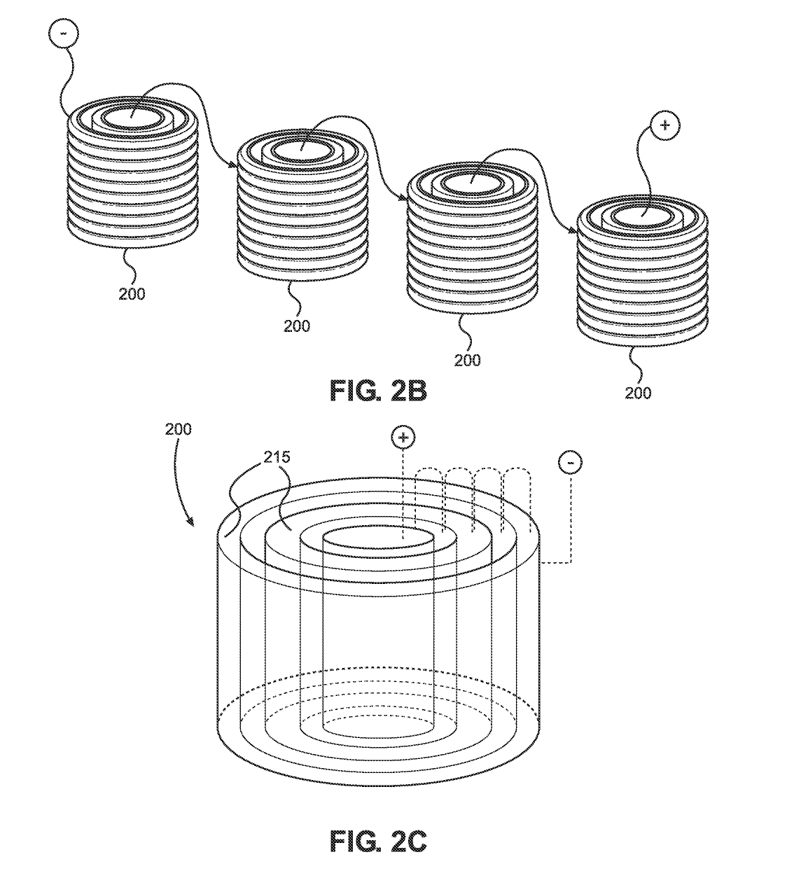

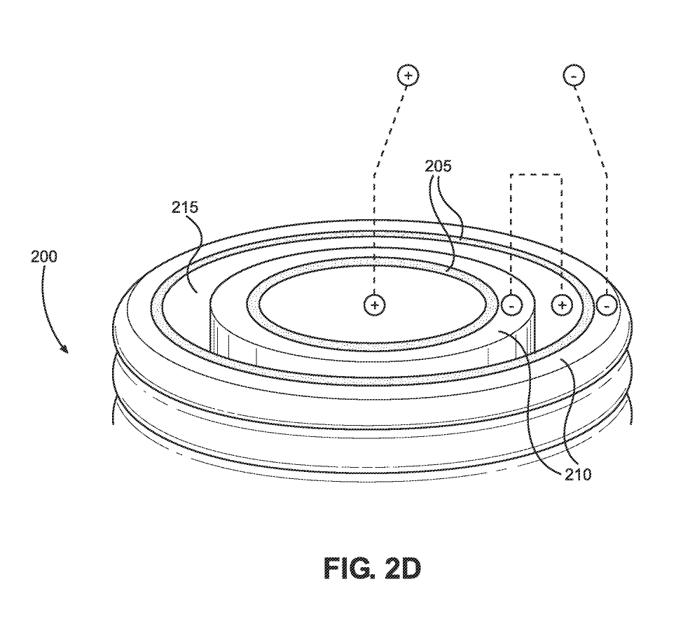

The present invention will now be described more fully with reference to the accompanying drawings. It should be understood that the invention may be embodied in many different forms and should not be construed as limited to the embodiments set forth herein. Throughout FIGS. 2-10, like elements of the invention are referred to by the same reference numerals for consistency purposes.

FIG. 2A shows a complete water cell 200. Water cell 200 is generally cylindrical in shape with a pair of electrodes—a positive anode (+) 205 shown nested, or stacked, within the negative cathode (−) 210. Two or more water cells 200 may be connected in series as shown in FIG. 2B to provide a power source of increased voltage and amperage over a single water cell 200. For each water cell 200, anode 205 is typically made of any type of metal that is used for galvanic cells which may include but not be limited to magnesium or zinc. Although the configuration of anode 205 may vary depending on the application in which it is being used, as an example, for a water cell 200 that is being used to power a small electronic device, anode 205 may have dimensions in the following ranges: (a) thickness—0.5 mm to 1.0 mm; (b) diameter—3.0 mm to 10.0 mm; and (c) height—10.0 mm to 15.0 mm. Of course, cell 200 may be used to supply power in any number of different applications requiring the dimensions to be measured in units ranging from nanometers for micro-electronics to meters for industrial electricity production.

Cathode 210 may be formed of a coil or it may be constructed of a solid sleeve of material. In FIG. 2A, cathode 210 is shown wrapped around anode 205. It is typically made of any metal which appears lower down on the periodic table of elements than the anode. For example, gold, silver or copper works well as the cathode material with zinc or magnesium as the anode. Although FIG. 2A shows water cell 200 constructed with anode 205 nested inside cathode 210, it should be understood that the two components may be reversed with resulting water cell 200 working equally effectively with cathode 210 being nested inside of anode 205.

As with the configuration of anode 205, the configuration of cathode 210 may vary depending on the application in which it is being used. Continuing with the example used with respect to anode 205 above for powering a small electronic device, cathode 210 may, for example, have dimensions in the following ranges: (a) thickness—0.5 mm to 1.0 mm; (b) diameter—12.0 mm to 18.0 mm; and (c) height—10.0 mm to 15.0 mm. Of course, as described above with respect to anode 205, cell 200 may be used to supply power in any number of different applications requiring the dimensions of cathode 210 to be compatible with anode 205. Therefore, cathode 210 is sized such that it is measured in units ranging from nanometers for micro-electronics to meters for industrial electricity production.

Cathode 210 may be formed of a coil or it may be constructed of a sleeve of material with or without perforations 225, slots or other spacing. As can be seen in FIG. 2A, anode 205 and cathode 210 are separated by a small gap 215 between an outer surface of anode 205 and an inner surface of cathode 210. For a small electronic appliance, gap 215 is typically in the range of 0.5 mm to 2.0 mm, and is filled with an absorbent conducting material 220 such as cloth, sponge or absorbent coatings applied to anode 105, cathode 210 or both. Perforations 225 (or slots or other spacings) allow the liquid and electrons to more easily pass between anode 205 and cathode 210.

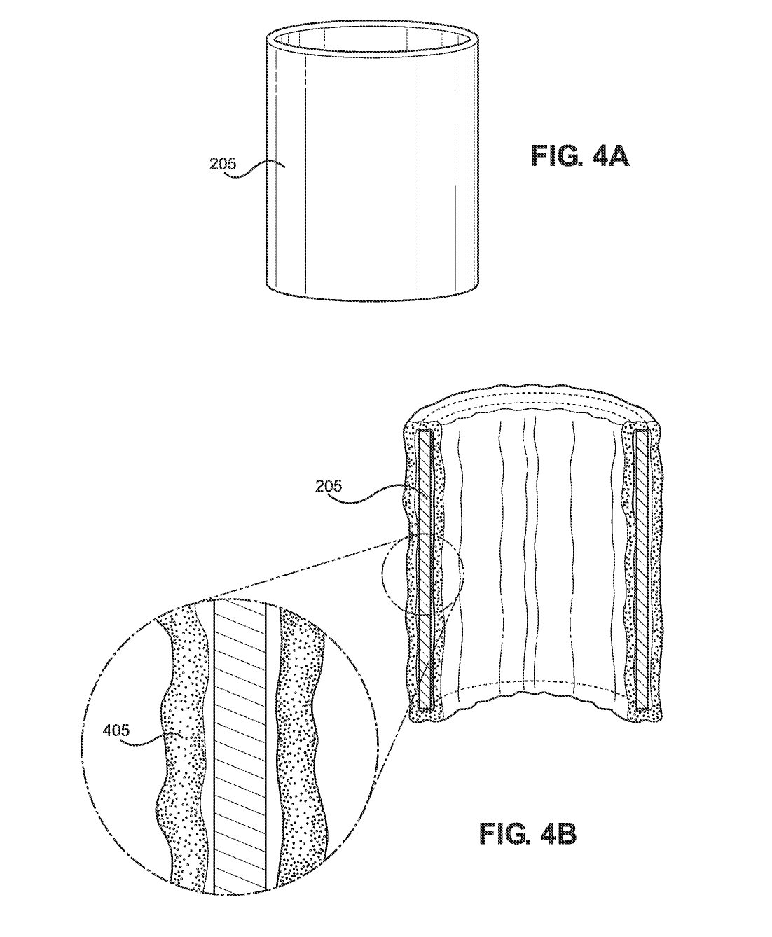

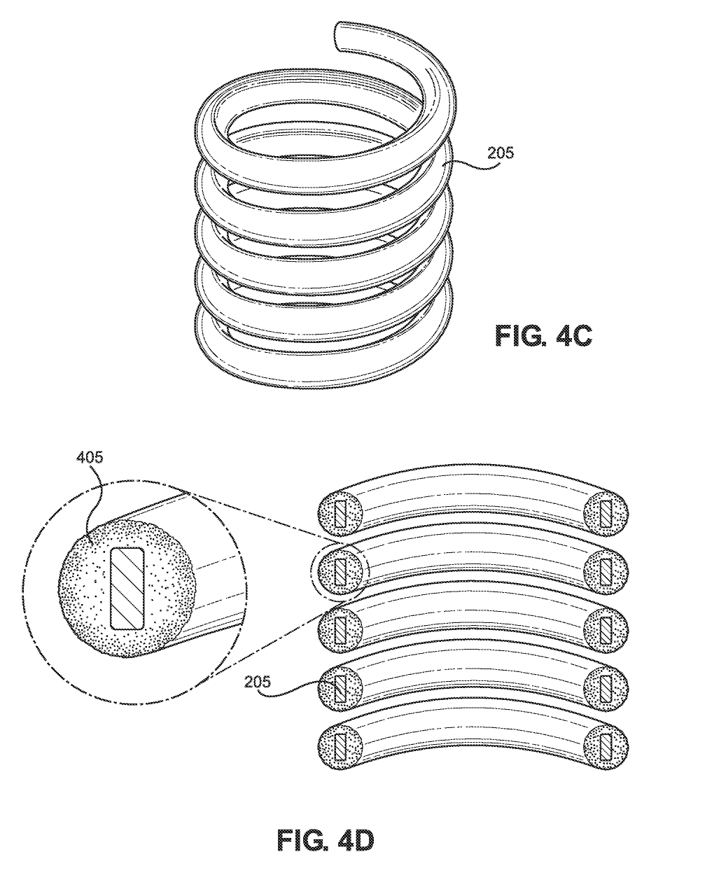

In addition to absorbent conducting material 220, a protective sealant coating 405 (see FIGS. 4B and 4D) that fully seals anode 205 and protects it from exposure to cathode 210. Protective sealant coating is typically formed of epoxy, paint or glue such as non-ferrous paints, coatings, sealants plastics, hot melt adhesives (9HMA), thermoplastic adhesive, ethylene-vinyl acetate (9EVA) or copolymers. The sealant coating 405 is applied to anode 205 before cathode 210 is wrapped around anode 205 during construction of water cell 200. The sealant may seal the components and all the wiring. The sealant may also be applied in a heating process to remove the oxygen from the metal surface in the application. The sealant coating resists liquid penetration preserving anode 205 and increasing the longevity of water cell 200 while still allowing electrons to freely pass between anode 205 and cathode 210 through absorbent conducting material 220.

Although a series of individual water cells 200 are shown in FIG. 2B, it should be understood that an alternative construction for a series of water cells 200 may be formed by fully integrating two or more water cells 200 together in a single structure as shown in FIGS. 2C-2D. As can be seen in the perspective side view of FIG. 2C and the perspective top view of FIG. 2D, a series of cathodes 215 wrapped around anodes 210 are nested one inside the next. The configuration of the individual anodes 205 and cathodes 210 is the same as described above with respect to FIGS. 2A and 2B. Multiple water cells 200 configured in a nested arrangement are connected using a first set of wires running between individual anodes 205 and a second set of wires running between individual cathodes 210. This multi-cell nested “onion” configuration saves space in comparison to the multi-cell structure of FIG. 2B.

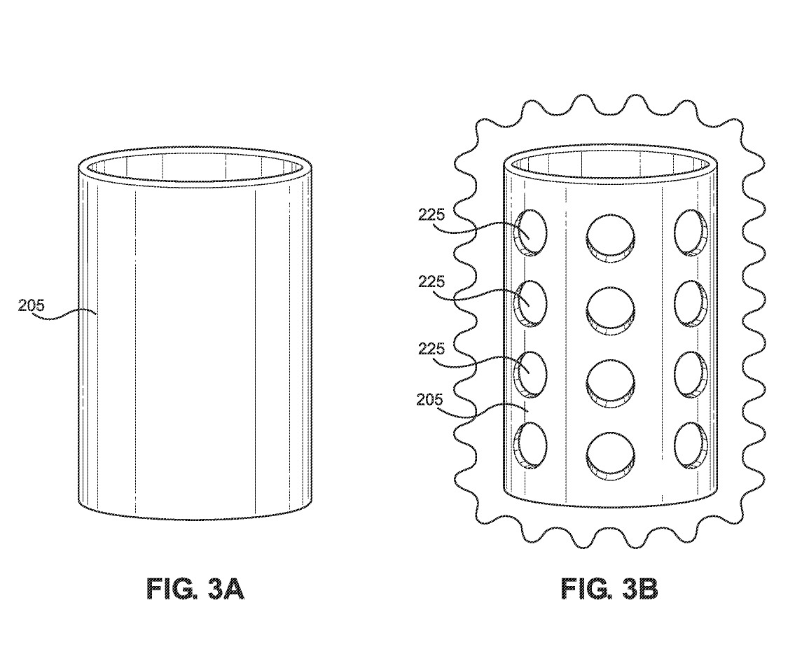

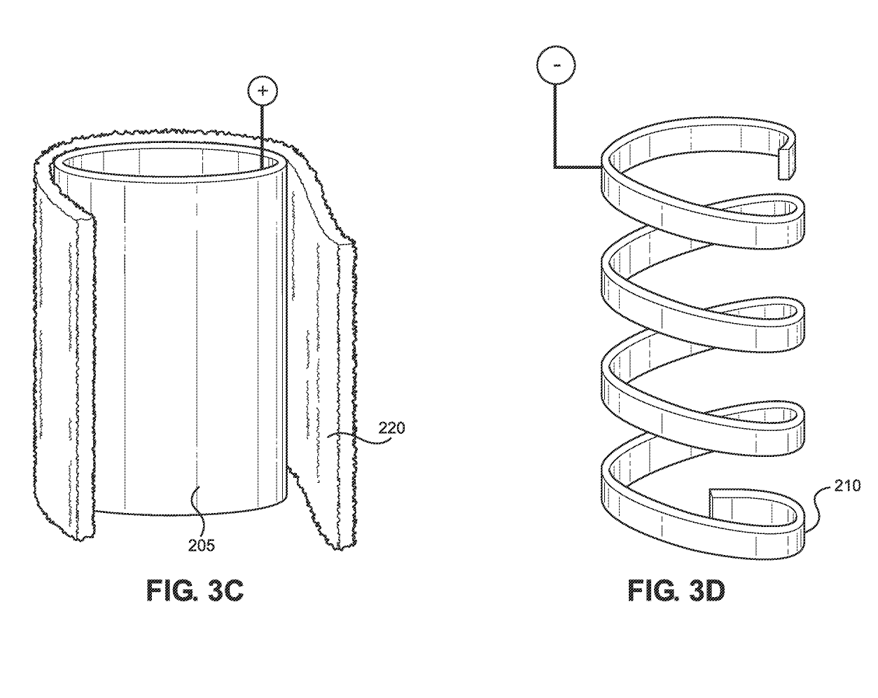

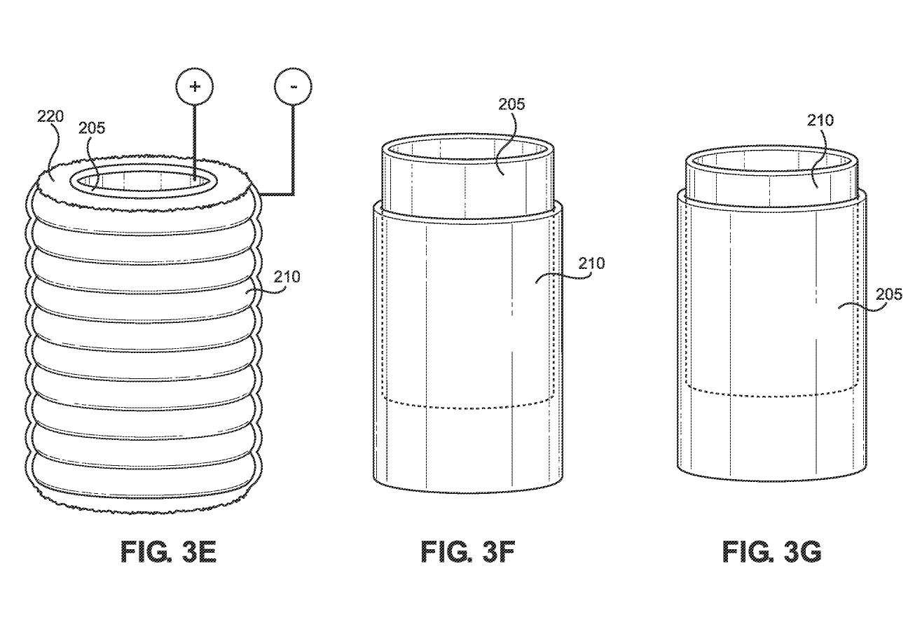

FIGS. 3A-G show the construction of a nested or stacked water cell 200. The construction starts in FIG. 3A with a solid cylindrically shaped anode (+) 205. Alternatively, anode (+) 205 may be formed with perforations 225 (or slots, grooves, ridges, holes or other spacings, formations or openings) that increase the surface area on anode (+) 205 as shown in FIG. 3B. FIG. 3C shows a cylindrically shaped piece of absorbent material 220 such as cloth or sponge wrapped around anode (+) 205 so that anode 205 is nested within absorbent material 220. Lastly, as shown in FIG. 3D, a cathode (−) 210 is formed of a piece of metal wire in a spiral or coil shape with continuously spiraling rings. Cathode (−) 210 may alternatively be a solid or perforated sleeve, but using a wire increases surface area and makes cathode 210 easy to form. Cathode 210 is placed around absorbent material 220 completing water cell 200 as shown in FIG. 3E. As described above with respect to FIG. 2A, alternative configurations of water cell 200 may be provided and work equally well with either: (1) cathode 210 wrapped around anode 205; or (2) with anode 205 wrapped around cathode 210. These two configurations are shown in FIGS. 3F and 3G respectively.

FIGS. 4A-4B and 4C-4D show alternative forms of an electrode which may be either an anode (+) 205 or cathode (−) 210 as a solid cylinder or a coil, respectively. As can be seen in the perspective view (FIG. 4A) and corresponding cutaway view (FIG. 4B), an anode 205 may be formed of solid cylindrical material, such as a metal that is higher on the periodic table than cathode 210. Alternatively, as can be seen in perspective view (FIG. 4C) and corresponding cutaway view (FIG. 4D), anode 205 may be formed from a solid piece of metal wound in a spiraling coil to form a cylindrical shape. In either case, a protective sealant coating 405 is applied to anode 205 to minimize oxidation thereby prolonging the life of anode 205. As described above, it should be understood that cathode 210 may be formed in a similar manner to anode 205 as either a cylindrically shaped sleeve or a coil formed in a cylindrical shape. Protective sealant coating 405 fully encapsulates anode 205 or cathode 210. Protective sealant 405 is typically formed of epoxy, paint, glue, sealant, plastic dip or spray, rubberized coating, hot melt adhesive (HMA), thermo-plastic adhesive, ethylene-vinyl acetate (9EVA) or co-polymer. Protective sealant coating 405 protects anode 205 from oxidation, but it permits the passage of ions and cations between anode 205 and cathode 210. In this way, electricity flows that may be used to provide power while protecting anode 205 from oxidation and deterioration that would otherwise shorten the life of water cell 200.

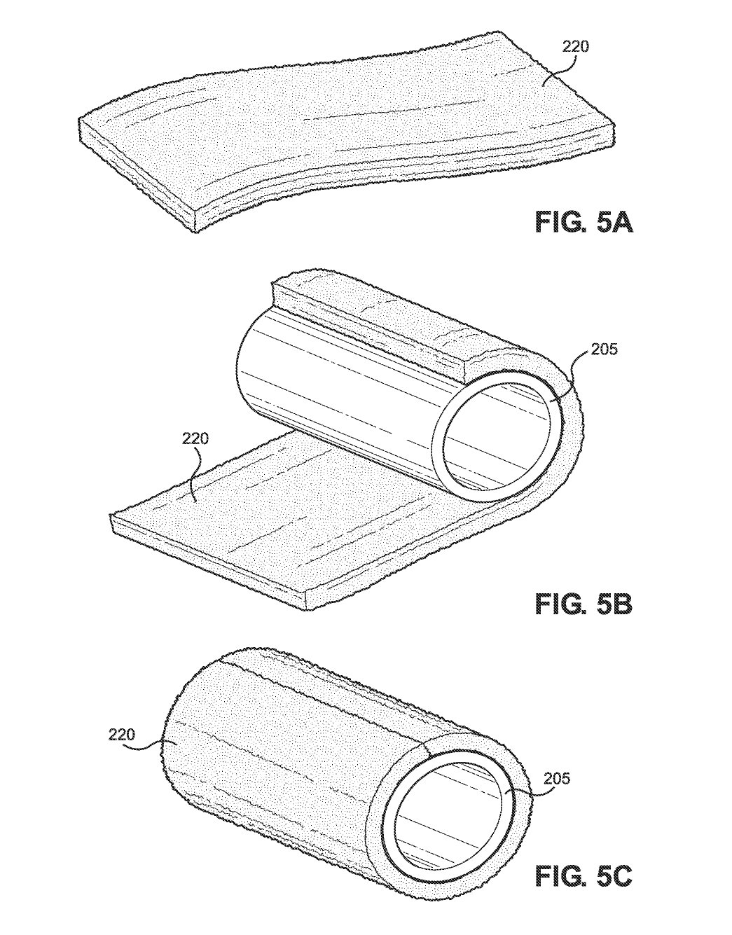

FIGS. 5A-C show views of absorbent material 220 cut in a rectangular shape so that it can be rolled into a cylindrical shape and wrapped around the inner component (anode 205 or cathode 210) of water cell 200. Absorbent material 220 is made of cloth, sponge or another suitable material that absorbs liquid that conducts electricity between anode 205 and cathode 210.

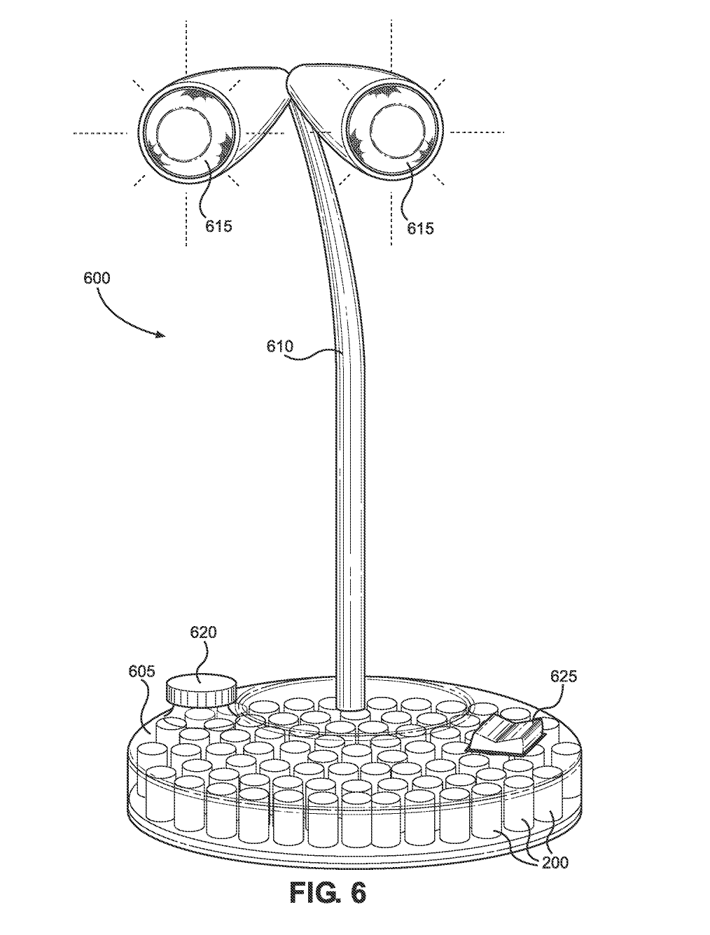

FIG. 6 shows a stand-up lamp 600 with a base 605, a stalk 610 and a pair of bulbs 615 that are powered by water cells 200. In this case, water cells 200 are located in a sealed and refillable container in base 605, and are connected serially as shown in FIG. 2B. The component parts, including the base are typically made of molded plastic or another non-corrosive material. Water cells 200 are visible through a transparent cover of base 605. It should be understood that each individual water cell 200 may be a series of nested cells as shown in FIGS. 2C and 2D. A removable cap 620 permits the refilling of base-container 605 with water. An on/off switch 625 is operable to switch on power to lamps 615 from one or more water cells 200 that are provided inside body 605 having a configuration as shown in FIGS. 2-5. Base

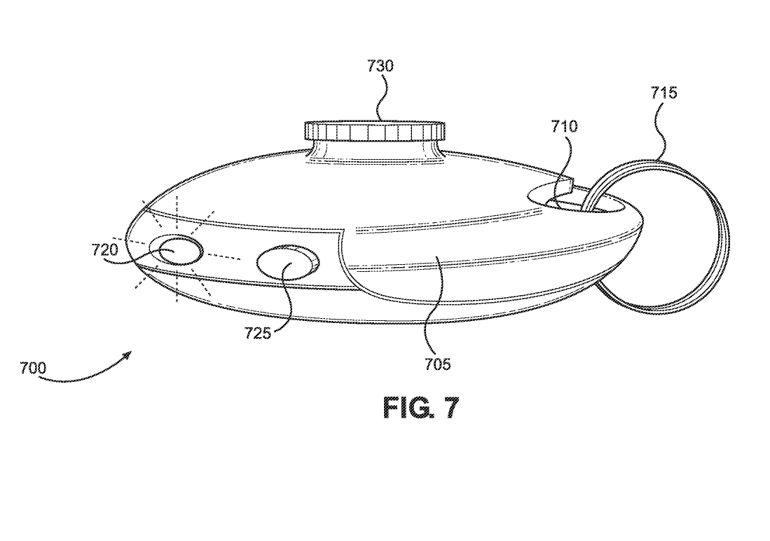

FIG. 7 shows a key chain light 700 having a body 705 with a hole 710 through which a keyring 715 and one or more bulbs 720 to provide illumination. An on/off switch 725 is operable to switch on power from one or more water cells 200 that are provided inside body 705 having a configuration as shown in FIGS. 2-5. A removable cap 730 permits the refilling of a reservoir inside of body 705 in which water cells 200 are positioned. It should be understood that each individual water cell 200 may be a series of nested cells as shown in FIGS. 2C and 2D. The component parts of keychain 700 including refillable body 705 are typically made of molded plastic.

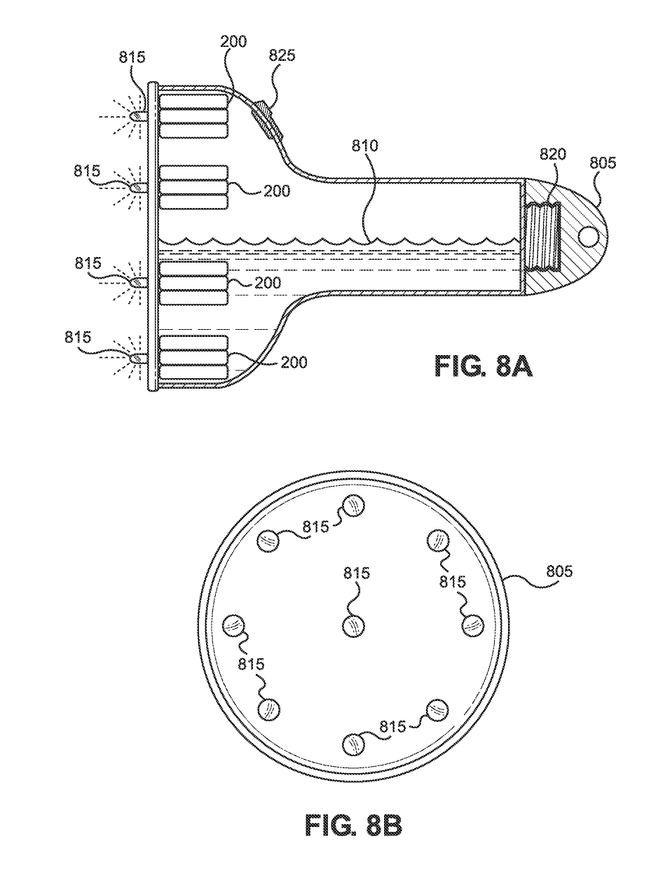

FIGS. 8A and 8B show a side view and front view respectively of a flashlight 800 powered by water cells 200. Flashlight 700 has a body 705 formed of plastic or another rigid material within which water cells 200 are positioned inside a water filled reservoir 810 that is a sealed and refillable container or reservoir. Water cells 200 are connected serially as shown in FIG. 2B. In the embodiment of FIG. 8, water cells 200 are visible through a transparent body 805. It should be understood that each individual water cell 200 may be a series of nested cells as shown in FIGS. 2C and 2D. A set of bulbs 815 such as LEDs for providing illumination are powered by water cells 200. A removable cap 820 permits the refilling of reservoir 810 with water. An on/off switch 825 is operable to switch on power to lamps 815 from one or more water cells 200 that are provided inside body 805 having a configuration as shown in FIGS. 2-5. The component parts of flashlight 800 including refillable body 805 are typically made of molded plastic.

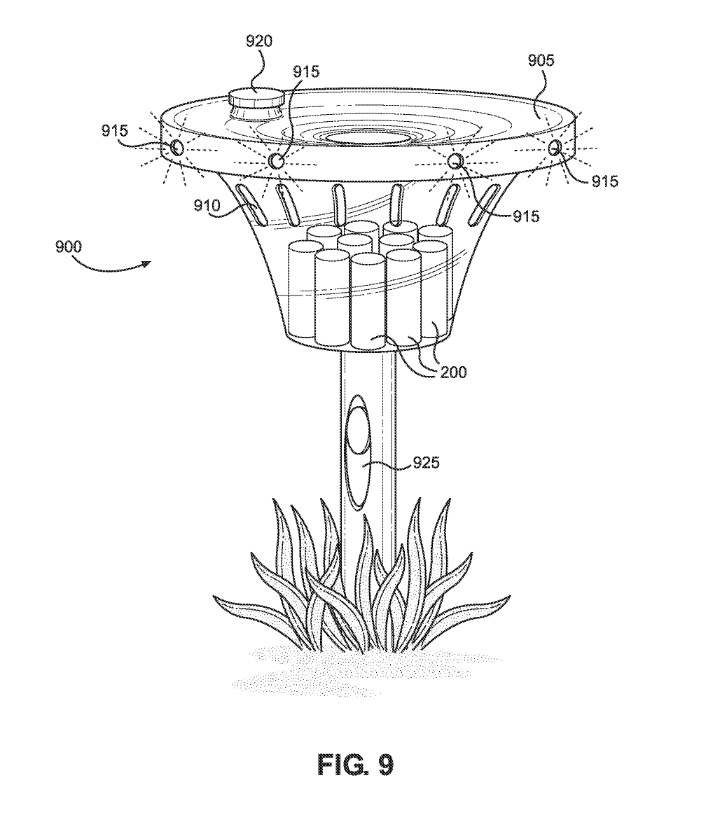

FIG. 9 shows a yard lamp 900 powered by water cells. Lamp 900 has a head 905 formed of plastic or another rigid material within which water cells 200 are positioned inside a water filled reservoir 910 that is a sealed and refillable container. Water cells 200 are connected serially as shown in FIG. 2B. In the embodiment of FIG. 9, water cells 200 are visible through head 905 which is made of transparent material. It should be understood that each individual water cell 200 may be a series of nested cells as shown in FIGS. 2C and 2D. A set of bulbs 915 such as LEDs for providing illumination are powered by water cells 200. A removable cap 920 permits the refilling of reservoir 910 with water. An on/off switch 925 is operable to switch on power to lamps 915 from one or more water cells 200 that are provided inside body 905 having a configuration as shown in FIGS. 2-5. The component parts of yard lamp 900 including refillable body 905 are typically made of molded plastic.

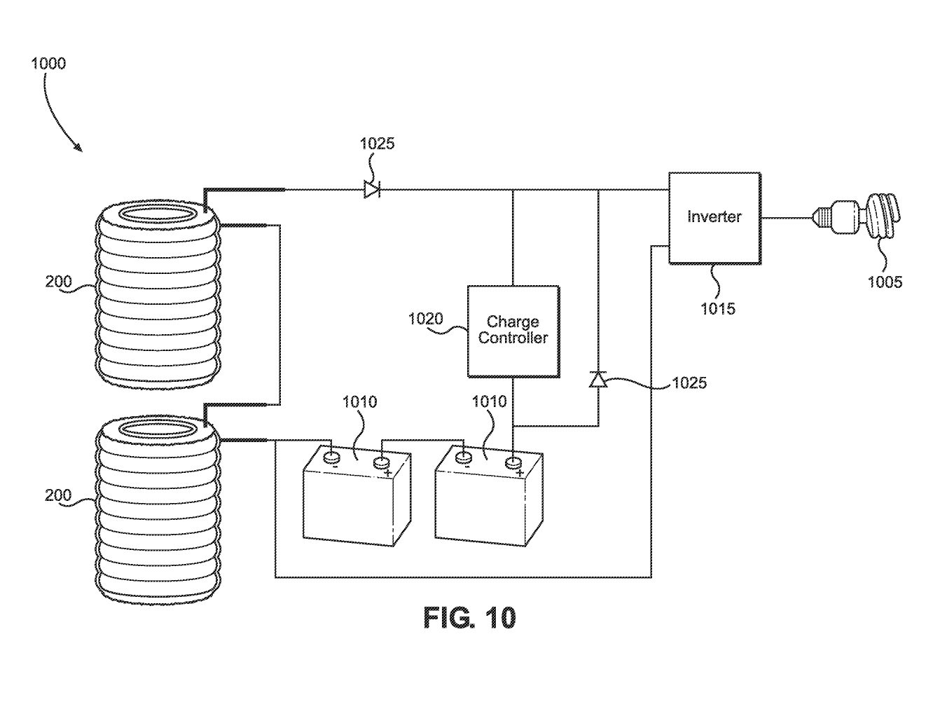

FIG. 10 is a block diagram of a circuit 1000 with a water cell providing power to one or more bulbs 1005 in a lamp. As can be seen, two or more water cells 200 may be connected in series as shown, or alternatively in parallel. By using multiple cells 200, the voltage and amperage levels can be provided as needed for the particular application. Cells 200 are connected to one or more batteries 1010 and one or more charge controllers 1015. The electrical output of batteries 1010 is inverted from direct current (DC) to alternating current (AC) by inverter 1020. Diodes 1025a, 1025b are used inline in circuit 1000 to protect cells 200, batteries 1010 and charge controller 1015 from any power surges.

While the invention has been described with respect to the figures, it will be appreciated that many modifications and changes may be made by those skilled in the art without departing from the spirit of the invention. For example, while the invention is described with reference to water cells powering bulbs in different types of lamps, it is also possible to provide power to other types of electrical and electronic devices. For example, a water cell of the type described may be used to power a clock, a speaker, a fan or any other device requiring a power source. The invention may be used in applications as varied as nanoelectronic components or as large as a large scale power station. Any variation and derivation from the above description and drawings are included in the scope of the present invention as defined by the claims.

What is claimed is:

1. An apparatus in the form of a cell for powering an electrical device comprising:
a first metallic electrode formed generally in the shape of a cylinder;
a second electrode formed generally in the shape of a cylinder with a diameter smaller than the first electrode wherein the second electrode is nested within the first electrode;
a coating deposited on at least one of the first electrode and the second electrode sealing an exterior surface of the at least one electrode;
a conductive absorbent material positioned between the first and second electrodes; and
a reservoir filled with liquid and within which the first electrode, the second electrode and the absorbent material are immersed and within which oxidation-reduction reactions occur.

2. The apparatus of claim 1 wherein at least one of the first or second electrodes is formed of wire configured in a coil to produce the shape of a cylinder.

3. The apparatus of claim 1 further comprising at least one additional set of electrodes and absorbent material nested with the first metallic electrode and the second metallic electrode in the reservoir to form a serial set of cells.

4. The apparatus of claim 1 further comprising:
at least one bulb in electrical connection with the first electrode and the second electrode; and
a switch with two positions connected between the at least one bulb and one of the first electrode or the second electrode, wherein when the switch is in a first position, power is provided to the bulb and when the switch is in a second position, no power is provided to the bulb.

5. The apparatus of claim 1 further comprising a removable cap fitted to the reservoir wherein the cap may be removed to add liquid to the reservoir.

6. The apparatus of claim 1 wherein at least one of the first or second electrodes is formed of a metallic material in the shape of a cylinder.

7. The apparatus of claim 6 wherein the first or second electrode has one or more formations of the type in the group comprising: (a) holes; (b) slots; (c) grooves; (d) indentations; (e) ridges; or (f) any other formation that provides an edge along the surface of the electrode.

8. The apparatus of claim 1 wherein the conductive material is formed of one of the group comprising: (a) sponge; (b) cloth; or (c) another flexible absorbent material.

9. The apparatus of claim 8 wherein the conductive material is formed in a flat and generally rectangular shape that is wrapped around the first electrode in the shape of a cylinder.

10. The apparatus of claim 1 further comprising a vacant hollow area in an internal area formed in the cylinder of the first electrode.

11. A method of providing powering to an electrical device using a cell comprising:
providing a first metallic electrode formed generally in the shape of a cylinder;
nesting a second electrode formed generally in the shape of a cylinder with a diameter smaller than the first electrode within the first electrode;
coating at least one of the first electrode and the second electrode wherein the coating seals an exterior surface of the at least one electrode;
positioning a conductive absorbent material between the first and second electrodes;
filling a reservoir with liquid; and
immersing the first electrode, the second electrode and the absorbent material within the reservoir wherein oxidation-reduction reactions occur; and
using the energy produced by the oxidation-reduction reactions to provide power.

12. The method of claim 11 wherein at least one of the first or second electrodes is formed of wire configured in a spiral to produce the shape of a cylinder.

13. The method of claim 11 further comprising the steps of providing at least one additional set of electrodes and absorbent material nested with the first metallic electrode and the second metallic electrode in the reservoir to form a serial set of cells.

14. The method of claim 11 further comprising:
providing at least one bulb in electrical connection with the first electrode and the second electrode; and
selecting a position on a switch with two positions connected between the at least one bulb and one of the first electrode or the second electrode, wherein when a first position on the switch is selected, power is provided to the bulb and when a second position on the switch is selected, no power is provided to the bulb.

15. The method of claim 11 further comprising removing a cap fitted to the reservoir and adding liquid to the reservoir.

16. The method of claim 11 wherein at least one of the first or second electrodes is formed of a metallic material in the shape of a cylinder.

17. The method of claim 16 wherein the first or second electrode has one or more openings of the type in the group comprising: (a) holes; (b) slots; (c) grooves; (d) indentations; (e) ridges; or (f) any other formation that provides an edge along the surface of the electrode.

18. The method of claim 11 wherein the conductive material is formed of one of the group comprising: (a) sponge; (b) cloth; or (c) another flexible absorbent material.

19. The method of claim 11 wherein the conductive material is formed in a flat and generally rectangular shape that is wrapped around the first electrode in the shape of a cylinder.

20. The method of claim 11 wherein a vacant hollow area is formed in an internal area of the first electrode.
